(19) United States
(12) Patent Application Publication
(10) Pub. No.: US 2025/0267475 A1
(43) Pub. Date: Aug. 21, 2025

(54) NETWORK-ASSISTED SENSING OF PASSIVE OBJECTS IN A TARGET AREA

(71) Applicant: HUAWEI TECHNOLOGIES CO., LTD., Shenzhen (CN)

(72) Inventors: Anastasios Kakkavas, Munich (DE); Richard Stirling-Gallacher, Munich (DE); Xitao Gong, Munich (DE); Mario Hernán Castañeda García, Munich (DE); Qi Wang, Munich (DE)

(73) Assignee: HUAWEI TECHNOLOGIES CO., LTD., Shenzhen (CN)

(21) Appl. No.: 19/204,356

(22) Filed: May 9, 2025

Related U.S. Application Data
(63) Continuation of application No. PCT/EP2022/081204, filed on Nov. 9, 2022.

(51) Int. Cl. H04W 16/28; H04L 5/00; H04W 64/00

(52) U.S. Cl. CPC H04W 16/28; H04L 5/0051; H04W 64/00

(57) ABSTRACT

A first device senses an object in a target area. The first device is operable to send, to a second device being connectible with the first device, an indication of one or more reference signal (RS) resources being associated with respective beams of the second device, and an indication of two or more angular offsets relative to a spatial direction of a respective beam being associated with the one or more RS resources. The two or more angular offsets include a line-of-sight (LOS) angular offset for a LOS link condition between the first device and the second device, and a non-line-of-sight (NLOS) angular offset for an NLOS link condition between the first device and the second device.

### CROSS-REFERENCE TO RELATED APPLICATIONS

This application is a continuation of International Application No. PCT/EP2022/081204, filed on Nov. 9, 2022, the disclosure of which is hereby incorporated by reference in its entirety.

### FIELD

The present disclosure relates generally to the field of mobile communications, and more specifically to network-assisted sensing of passive objects in a target area.

### BACKGROUND

Current communications systems, like 3^{rd} generation partnership project (3GPP) Long Term Evolution (LTE) and New Radio (NR), support the localization of active devices, i.e. devices that are involved in the transmission (Tx) or reception (Rx) of the signal used for localization. However, it is envisioned that the functionality of sensing passive objects, i.e. objects that do not participate in the Tx/Rx of the signal used for sensing, will be integrated with the communication functionality of upcoming communication systems, e.g. 5G Advanced or 6G. As used herein, sensing may refer not only to the estimation of the position of an object, but also to its detection, as well as its shape and even its material.

From a transceiver deployment point of view, two different sensing approaches exist. Monostatic sensing may refer to the sensing transmitter and the receiver are collocated and the device may sense its environment. Full-duplex operation is required in this case. In case of multistatic sensing, the sensing transmitter and the receiver are at different locations and network-related operations are required for the sensing measurements. As this approach does not require full-duplex operation and can re-use existing communication waveforms, e.g., orthogonal frequency division multiplexing (OFDM), discrete Fourier transform-spread-OFDM (DFT-s-OFDM), it can be more easily integrated to the current specification. FIGS. 1 to 3 illustrate different variants of multistatic sensing.

For convenience of exposition, an uplink (UL) or sidelink (SL) multi-static sensing scenario as depicted in FIG. 1 or 2 is considered, where a given target area to be sensed is known to a base station (BS), e.g. next-generation Node B (gNB), and/or to a location server (LS), e.g. location management function (LMF), and a group of user equipments (UEs) has been selected to illuminate the target area by transmitting a beamformed signal in its direction. If UE orientation and position were available at the UE, the BS could signal the coordinates of the target area to the UE and the UE could choose its spatial filter/beam accordingly. Nevertheless, some UEs may not know their orientation. Note that even if the UE's codebook is known to the BS/LS, it is not known where each beams points to, due to the unknown UE orientation.

To alleviate the need for orientation information, the BS/LS can use beam correspondence to configure the UE's transmission. The beam correspondence concept is defined as follows: The BS/LS can indicate to the UE to transmit on a beam/spatial filter with which it has previously received a specific reference signal (RS) resource, e.g. synchronization signal block (SSB), channel state information-RS (CSI-RS) or transmitted a specific RS, e.g. uplink sounding reference signal (UL-SRS). Generally, an RS resource may refer to a set of time-frequency resource elements that constitute part of an RS transmission and is typically coupled with a specific spatial filter, through which the transmission takes place. So without knowledge of the UE's orientation at the BS/LS and the UE, the BS/LS can configure the UE's transmission to the target area relative to a reference beam/direction indicated by the RS resource. The configuration of the UE's spatial filter for reception, so as to receive signals coming from the direction of the target follows a similar principle: in the DL and/or the SL of the system, the BS/LS may use a reference resource, which may be indicated through quasi-colocation (QCL) type D information, to configure the UE's Rx spatial filter without knowledge of the UE's orientation at the BS/LS and the UE. If RS resources A and B are quasi-co-located type D, it means that a same spatial filter is suitable for reception of the RS resources A and B, respectively.

The target area may thus be indicated to the UE as an angular offset with respect to a reference beam/direction indicated by an RS resource which has been used in a previous transmission.

The prior art solution can be successfully applied to the sensing setup if the BS-UE link condition, i.e., whether the link is line of sight (LOS) or non-line of sight (NLOS), is known to the BS/LS. Depending on the link condition, the BS can compute an appropriate offset with respect to the reference beam, so that the UE transmission illuminates the target area. In practice, the BS/LS may not know whether the link is LOS or NLOS. In case the BS/LS falsely assumes a specific link condition (LOS/NLOS), it will falsely compute the UE beam to be used to illuminate the target area.

Accordingly, there is a need for a scheme to configure beamformed transmissions from the UE when orientation information is not available that is more robust with respect to the BS-UE link condition.

### SUMMARY

Aspects of the present disclosure overcome the above-mentioned and other drawbacks.

According to a first aspect, a first device is provided for sensing of an object in a target area. The first device is operable to send, to a second device being connectible with the first device, an indication of one or more reference signal, RS, resources being associated with respective beams of the second device, and an indication of two or more angular offsets relative to a spatial direction of a respective beam being associated with the one or more RS resources. The two or more angular offsets comprise a line-of-sight, LOS, angular offset for a LOS link condition between the first device and the second device, and a non-line-of-sight, NLOS, angular offset for an NLOS link condition between the first device and the second device.

A target area as used herein may refer to a portion of a coverage area of a mobile communication system.

A reference signal (RS) resource as used herein may refer to a set of time-frequency resource elements that constitute part of the RS transmission in a mobile communication system and are typically coupled with a specific spatial filter through which a transmission takes place. An RS can consist of multiple resources.

A beam or spatial filter as used herein interchangeably may refer to a result of beamforming or spatial filtering, i.e., a signal processing technique used for directional signal transmission or reception (spatial directivity/selectivity), by combining elements in an antenna array in such a way that signals at particular angles experience constructive interference while others experience destructive interference.

An angular offset as used herein may refer to an angle between two vectors in a same plane.

A line-of-sight (LOS) link condition as used herein may refer to a circumstance wherein radio waves travel in a straight line from a transmitter to a receiver.

A non-line-of-sight (NLOS) link condition as used herein may refer to a circumstance wherein radio waves do not travel in a straight line from a transmitter to a receiver.

By providing multiple spatial relations and corresponding angular offsets with respect to one or more RS resources for the configuration of the UE's spatial filter for the transmission/reception of a single RS resource, the present disclosure
avoids a use of multiple resources for sensing the object in the target area, resulting in lower resource overhead,
exploits the UE's capability to have a more accurate and up-to-date estimate of the BS-UE link condition through the RS resource (compared to that of the LS/BS) and select the appropriate offset to sense the object in the target area, and
exploits the fact that the UE might have higher confidence on the BS-UE link condition through a specific reference resource compared to others.

In a possible implementation form, the first device may further be operable to receive a report from the second device.

In a possible implementation form, the first device may further be operable to receive, from a third device being connectible with the first device, one or more of: the indication of the one or more RS resources, and the indication of the two or more angular offsets: and to send a report to the third device.

In a possible implementation form, the first device may further be operable to provide, to the second device, an indication of the link condition between the first device and the second device, for each of the two or more angular offsets.

Providing an indication of the BS-UE link condition through the RS resource to which an angular offset corresponds allows the UE to make use of its estimated LOS/NLOS probability of the BS-UE link through the RS resource and decide whether the angular offset is useful for sensing the object in the target area.

According to a second aspect, a third device is provided for sensing of an object in a target area. The third device is operable to send, to a first device being connectible with the third device, one or more of: an indication of one or more reference signal, RS, resources being associated with respective beams of a second device, and an indication of two or more angular offsets relative to a spatial direction of a respective beam being associated with the one or more RS resources. The two or more angular offsets comprise a line-of-sight, LOS, angular offset for a LOS link condition between the first device and the second device, and a non-line-of-sight, NLOS, angular offset for an NLOS link condition between the first device and the second device.

In a possible implementation form, the third device may further be operable to receive a report from the first device.

In a possible implementation form, the third device may comprise a location server, LS.

A location server (LS) as used herein may refer to a location management function (LMF) of a mobile communication system.

In a possible implementation form, the first device or the third device may further be operable to calculate the LOS angular offset based on one or more of: a location of the first device, a location of the second device, and a location information being associated with the target area.

A location as used herein may refer to a geographic position as specified by geographic coordinates.

A location information as used herein may refer to a geographic locality as exemplified by geographic coordinates.

In a possible implementation form, the first device or the third device may further be operable to calculate the NLOS angular offset based on one or more of: the location of the first device, the location of the second device, the location information being associated with the target area, a measurement being associated with a propagation distance of an NLOS path between the first device and the second device, and a measurement being associated with a deflection angle of the NLOS path from a boresight direction at the first device.

A boresight direction as used herein may refer to an axis of maximum gain (maximum radiated power) of a directional antenna system. For most antennas the boresight direction is an axis of symmetry of the antenna.

In a possible implementation form, the first device may further be operable to receive, from the second device, one or more of: an indication of one of the one or more RS resources being associated with a spatial filter of the second device, an indication of one of the two or more angular offsets being associated with the spatial filter of the second device, and an indication of a LOS probability being associated with the indicated one of the one or more RS resources.

In a possible implementation form, the first device may comprise one of: a base station, and a user equipment.

A base station (BS) as used herein may refer to a stationary cell site of a mobile communication system being operable to provide spatially directive/selective connectivity with mobile communications stations (i.e., mobile terminals) of the mobile communication system. Examples include a gNB (5G base station) and an eNB (4G base station).

A user equipment (UE) as used herein may refer to a mobile terminal of a mobile communication system.

According to a third aspect, a second device is provided for sensing of an object in a target area. The second device is operable to receive, from a first device being connectible with the second device, an indication of one or more reference signal. RS, resources being associated with respective beams of the second device, and an indication of two or more angular offsets relative to a spatial direction of a respective beam being associated with the one or more RS resources. The two or more angular offsets comprise a line-of-sight, LOS, angular offset for a LOS link condition between the first device and the second device, and a non-line-of-sight, NLOS, angular offset for an NLOS link condition between the first device and the second device: to configure a spatial filter of the second device in a spatial direction toward the target area based on one of the one or more RS resources, and on one of the two or more angular offsets in accordance with an actual link condition between the first device and the second device as observed by the second device: and probe the target area using the configured spatial filter.

The procedure that the UE selects one of the provided offsets and respective reference resource to be used for the configuration of its Tx/Rx spatial filter based on its estimates of the LOS/NLOS probability of the BS-UE link through the provided reference resources exploits the UE's capability to have a more accurate and up-to-date estimate of the BS-UE link condition through the reference resource and select the appropriate angular offset to sense the object in the target area.

In a possible implementation form, the second device may further be operable to: send a report to the first device.

In a possible implementation form, the second device may comprise one of: a base station or a transmission/reception point in downlink communication, a user equipment in uplink communication, and a user equipment in sidelink communication. The second device may further be operable to probe the target area using the configured spatial filter by transmitting a probe signal.

A transmission/reception point (TRP or TRxP) as used herein may refer to a stationary antenna array (i.e., array of antenna elements) of a mobile communication system.

A downlink (DL) communication as used herein may refer to a transmission in a mobile communication system from a BS to a UE.

An uplink (UL) communication as used herein may refer to a transmission in a mobile communication system from a UE to a BS.

A sidelink (SL) communication as used herein may refer to a direct transmission in a mobile communication system between UEs.

A probe signal as used herein may refer to a radio signal for downlink, uplink or sidelink communication.

In a possible implementation form, the second device may comprise one of: a user equipment in downlink communication, a base station or a transmission/reception point in uplink communication, and a user equipment in sidelink communication. The second device may further be operable to probe the target area using the configured spatial filter by receiving the probe signal.

In a possible implementation form, the second device may further be operable to receive, from the first device, an indication of the link condition between the first device and the second device, for each of the two or more angular offsets.

In a possible implementation form, the second device may further be operable to provide, to the first device, one or more of: an indication of one of the one or more RS resources being associated with the spatial filter of the second device, an indication of one of the two or more angular offsets being associated with the spatial filter of the second device, and an indication of a LOS probability being associated with the indicated one of the one or more RS resources.

The procedure that UEs report their selected angular offset among the provided list, along with their estimate about the LOS/NLOS probability of the BS-UE link through the respective RS resource to the LS/BS may exploit this information in the sensing task-related computations of the LS/BS, e.g. in the computation of the location of the passive object.

In a possible implementation form, the one or more RS resources may respectively comprise one of: a synchronization signal block, SSB, in downlink communication: a channel state information-reference signal, CSI-RS, in downlink communication: and an uplink sounding reference signal, UL-SRS, in uplink communication.

A synchronization signal block (SSB) as used herein may refer to RS resources used in downlink communication of a 5G mobile communication system for representing a cell identity (PCI) and carrying important broadcast information.

A channel state information-reference signal (CSI-RS) as used herein may refer to RS resources used in downlink communication of a 5G mobile communication system for channel sounding.

An uplink sounding reference signal (UL-SRS) as used herein may refer to RS resources used in uplink communication of a 5G mobile communication system for channel sounding.

In a possible implementation form, the LOS angular offset and the NLOS angular offset may respectively comprise one or more of: a horizontal angular offset: and a vertical angular offset.

A horizontal angular offset as used herein may refer to an angle between two vectors in a horizontal plane.

A vertical angular offset as used herein may refer to an angle between two vectors in a vertical plane, wherein the vertical plane is perpendicular to the horizontal plane just mentioned.

According to a fourth aspect, a system is provided, comprising a first device according to the first aspect or any of its implementations: and two or more second devices according to the third aspect or any of its implementations.

In a possible implementation form, the system may further comprise a third device according to the second aspect or any of its implementations.

### BRIEF DESCRIPTION OF DRAWINGS

The above-described, and other, aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 illustrates an exemplary UL multistatic sensing scenario in accordance with the present disclosure;

FIG. 2 illustrates an exemplary SL multistatic sensing scenario in accordance with the present disclosure;

FIG. 3 illustrates an exemplary DL multistatic sensing scenario in accordance with the present disclosure;

FIG. 4 illustrates a LOS link condition between a first device and a second device;

FIG. 5 illustrates a NLOS link condition between a first device and a second device;

FIG. 6 illustrates a system in accordance with the present disclosure; and

FIG. 7 illustrates an exemplary multistatic sensing scenario in accordance with the present disclosure involving a moving second device.

### DETAILED DESCRIPTION

In the following description, reference is made to the accompanying drawings, which form part of the disclosure, and which show; by way of illustration, specific aspects of implementations of the present disclosure or specific aspects in which implementations of the present disclosure may be used. It is understood that of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary implementations and/or aspects described herein may be combined with each other, unless specifically noted otherwise.

Multi-static sensing, with UEs acting as transmitters and/or receivers, is expected to be used in many of the envisioned sensing use cases to be realized in 3GPP 5G-Advanced and 6G systems, due to its compatibility with, and, hence, its ease of integration to the current mobile communication systems' architecture. Example use cases include environment mapping, vulnerable road user protection, intruder detection, remote health monitoring (e.g. respiration/heart rate measurement, fall detection), etc. Taking the intruder detection use case as an example, beams used in mobile communications may be steered in the direction of possible intrusion points to detect any change in a probe signal due to a presence of an intruder and trigger an alarm.

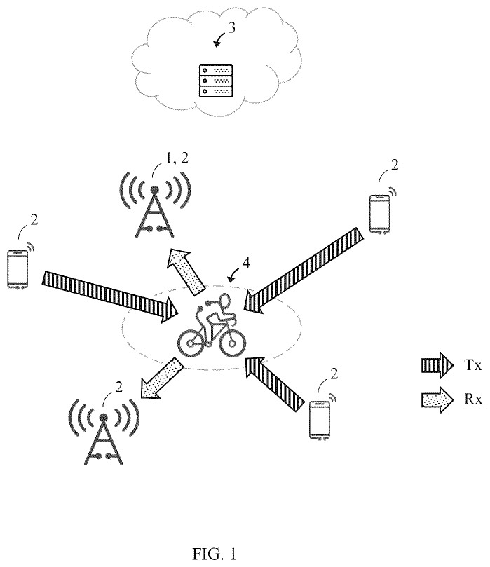

The present disclosure targets UEs, including among others hand-held terminal devices, in-vehicle devices and robots, involved in a multi-static sensing task in the DL, UL or SL of a communication system (e.g. see FIGS. 1-3) and may have no or less reliable orientation information.

FIG. 1 illustrates an exemplary UL multistatic sensing scenario in accordance with the present disclosure.

Depicted is a non-limiting exemplary system 1, 2, 3 comprising a first device 1 according to the first aspect of the present disclosure or any of its implementations, five (i.e., two or more) second devices 2 according to the third aspect or any of its implementations, and optionally a third device 3 according to the second aspect or any of its implementations.

The third device 3, if provided, comprises an LS, the first device 1 comprises a BS, and the respective second device 2 comprises a UE in UL transmission or a BS in UL reception. respectively, in accordance with the intended UL multistatic sensing.

The UEs among the second devices 2 have been selected to illuminate the target area 4 by transmitting a beamformed probe signal in its direction. The selection of the second devices 2 participating in the sensing is out of the scope of the present disclosure.

Note that one of the BSs combines the first device 1 and one of the second devices 2, and may thus be operable to instruct/configure the second devices 2 for the sensing, and further to participate in the sensing, in this case by receiving a probe signal.

The target area 4 to be sensed and the positions of the second devices 2 are known to the first device 1 (or the third device 3, if provided).

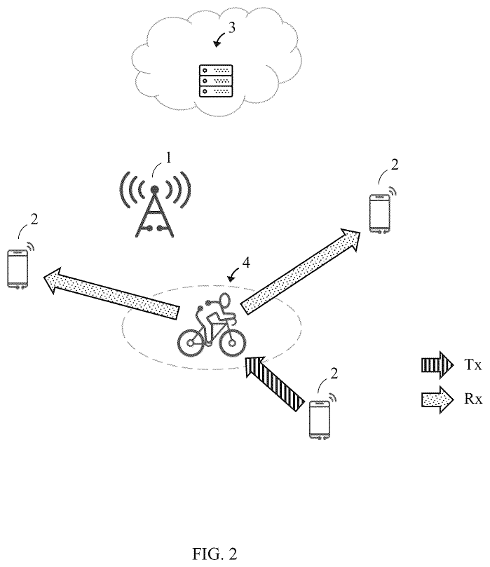

FIG. 2 illustrates an exemplary SL multistatic sensing scenario in accordance with the present disclosure.

The depicted non-limiting exemplary system 1, 2, 3 now comprises a first device 1, three (i.e., two or more) second devices 2, and optionally a third device 3.

The third device 3, if provided, comprises an LS, the first device 1 comprises a BS, and the respective second device 2 comprises a UE in SL transmission or a UE in SL reception, respectively, in accordance with the intended SL multistatic sensing.

The UEs among the second devices 2 have been selected to illuminate the target area 4 by transmitting a beamformed probe signal in its direction, or to be receptive for any probe signal incident from a direction of the target area 4.

Again, the target area 4 to be sensed and the positions of the second devices 2 are known to the first device 1 (or the third device 3, if provided).

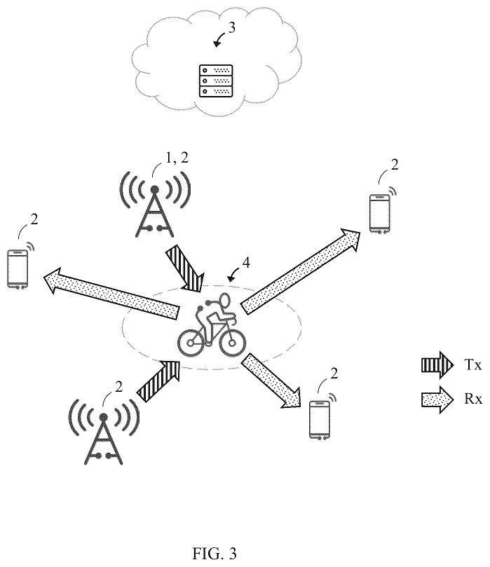

FIG. 3 illustrates an exemplary DL multistatic sensing scenario in accordance with the present disclosure.

The non-limiting exemplary illustrated system 1, 2, 3 now comprises a first device 1, five (i.e., two or more) second devices 2, and optionally a third device 3.

The third device 3, if provided, comprises an LS, the first device 1 comprises a BS, and the respective second device 2 comprises a BS in DL transmission or a UE in DL reception, respectively, in accordance with the intended DL multistatic sensing.

The BSs among the second devices 2 have been selected to illuminate the target area 4 by transmitting a beamformed probe signal in its direction, and the UEs among the second devices 2 have been selected to be receptive for any probe signal incident from a direction of the target area 4.

Note that one of the BSs combines the first device 1 and one of the second devices 2, and may thus be operable to instruct/configure the second devices 2 for the sensing, and further to participate in the sensing, in this case by transmitting a probe signal.

Naturally, the target area 4 to be sensed and the positions of the second devices 2 are known to the first device 1 (or the third device 3, if provided).

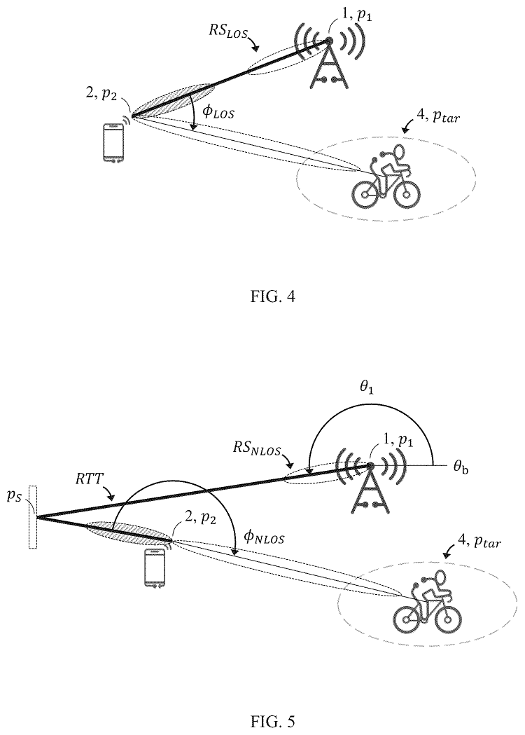

FIG. 4 illustrates a LOS link condition between a first device 1 and a second device 2.

In this non-limiting example, the first device 1 comprises a BS, and the second device 2 comprises a UE.

The location p₁=[p_{1,x} p_{1,y}] of the first device 1, the location p₂=[p_{2,x} p_{2,y}] of the second device 2 and the location information pₜₐᵣ=[p_{tar,x} p_{tar,y}] being associated with the target area 4 (e.g., its center) are all known to the first device 1 (or the third device 3, if provided). As such, the first device 1 (or third device 3) may calculate a spatial direction to be used by the second device 2 so as to probe the target area 4. Likewise, the locations may be expressed in non-cartesian coordinates, too, such as polar coordinates. In case of a three-dimensional calculation, the locations may be expressed in cartesian coordinates (i.e., including a z-coordinate component) or in spherical coordinates, for instance.

An RS resource RS_{LOS} may be associated with a beam (indicated in FIG. 4 as a cross-hatched ellipsis) of the second device 2 which has been used in a previous transmission.

Given the LOS link (indicated in FIG. 4 as a thick solid line) between the first device 1 and the second device 2, the first device 1 (or third device 3) may therefore calculate a LOS angular offset ϕ_{LOS} relative to a spatial direction of said beam being associated with said RS resource RS_{LOS}as follows:

$${ϕ}_{LOS} = a tan ( {p}_{tar , y} - {p}_{2 , y} , {p}_{tar , x} - {p}_{2 , x} ) - a tan ( {p}_{1 , y} - {p}_{2 , y} , {p}_{1 , x} - {p}_{2 , x} ) \qquad ( 1 )$$

wherein atan is the four-quadrant inverse tangent function. A three-dimensional calculation may involve an additional third term in equation (1) relating to z-coordinate components.

FIG. 5 illustrates a NLOS link condition between a first device 1 and a second device 2.

Again, the location p₁=[p_{1,x} p_{1,y}] of the first device 1, the location p₂=[p_{2,x} p_{2,y}] of the second device 2 and the location information pₜₐᵣ=[p_{tar,x} p_{tar,y}] being associated with the target area 4 (e.g., its center) are all known to the first device 1 (or the third device 3, if provided). The first device 1 (or third device 3) may thus calculate a spatial direction to be used by the second device 2 so as to probe the target area 4. Previous specifications relating to other coordinate systems apply likewise.

An RS resource RS_{NLOS} may be associated with the beam (indicated in FIG. 5 as a cross-hatched ellipsis) of the second device 2 which has been used in a previous transmission.

Given the NLOS link (indicated in FIG. 5 as a thick solid folded line) between the first device 1 and the second device 2, applying the LOS angular offset ϕ_{LOS} relative to the spatial direction of said beam would provide an incorrect result.

The first device 1 (or third device 3) therefore has to exploit some additional information in order to calculate a correct NLOS angular offset ϕ_{NLOS} relative to a spatial direction of said beam being associated with said RS resource RS_{NLOS}.

More specifically, the calculation may further be based on a geometric consideration involving
a measurement RTT being associated with a propagation distance of an NLOS path between the first device 1 and the respective second device 2 (e.g., round trip time (RTT)), and
a measurement θ₁ being associated with a deflection angle of the NLOS path from a boresight direction θ_{b} at the first device 1 (e.g. angle of arrival (AOA) and/or angle of departure (AOD) at the first device 1):

$${ϕ}_{NLOS} = a tan ( {p}_{tar , y} - {p}_{2 , y} , {p}_{tar , x} - {p}_{2 , x} ) - a tan ( {p}_{S , y} - {p}_{2 , y} , {p}_{S , x} - {p}_{2 , x} ) \qquad ( 2 )$$

wherein a potential scattering/reflection point p_{S}=[p_{S,x} p_{S,y}] of the NLOS path may be derived from the geometric relationships:

$$‖ {p}_{1} - {p}_{S} ‖ + ‖ {p}_{2} - {p}_{S} ‖ = RTT / 2 \qquad ( 3 )$$

$$tan ( {θ}_{1} ) = \frac{{p}_{S , y} - {p}_{1 , y}}{{p}_{S , x} - {p}_{1 , x}} \qquad ( 4 )$$

A three-dimensional calculation may involve additional third terms in equations (2)-(4) relating to z-coordinate components.

For example, the measurement RTT being associated with the propagation distance of the NLOS path may involve one of: a Reference Signal Received Power (RSRP), a Received Signal Strength Indicator (RSSI), a Signal to Interference and Noise Ratio (SINR), a Reference Signal Time Difference (RSTD), a Relative Time Of Arrival (RTOA) and an Rx-Tx time difference measurement.

For example, the measurement θ₁ being associated with the deflection angle of the NLOS path may include one of: an RSRP and an Uplink Angle-Of-Arrival (UL-AOA) measurement.

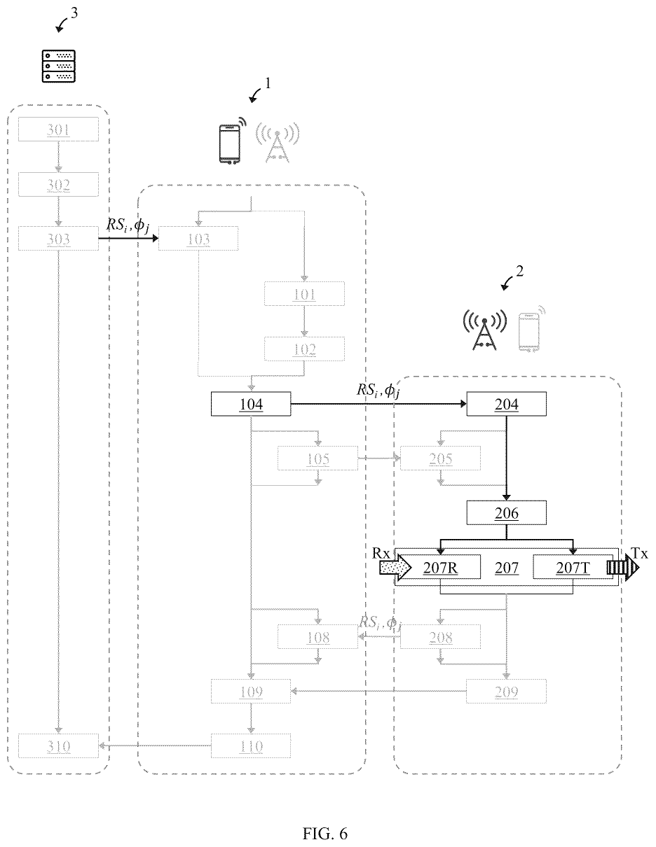

FIG. 6 illustrates a system 1, 2, 3 in accordance with the present disclosure.

The non-limiting exemplary system 1, 2, 3 comprises a first device 1 for sensing of an object in a target area 4 according to the first aspect or any of its implementations, further comprises two or more second devices 2 for sensing of an object in a target area 4 according to the third aspect or any of its implementations, of which only one second device 2 is illustrated for reasons of simplicity, and may further comprise a third device 3 for sensing of an object in a target area 4 according to the second aspect or any of its implementations.

The third device 3 (top left of FIG. 6) may comprise an LS, e.g. an LMF of a 3GPP mobile communication system, and may be operable to centrally instruct/configure the second devices 2 for sensing of an object in a target area 4, with the involvement of the first device 1.

If provided, and when receiving a sensing measurement request, e.g. from another network entity, the third device 3 is operable to calculate 301 a line-of-sight, LOS, angular offset ϕ_{LOS}for a LOS link condition between the first device 1 and the respective second device 2 based on one or more of: a location p₁=[p_{1,x} p_{1,y}] of the first device 1, a location p₂=[p_{2,x} p_{2,y}] of the respective second device 2, and a location information pₜₐᵣ=[p_{tar,x} p_{tar,y}] being associated with the target area 4 (see equation (1) above).

The third device 3 may further be operable to calculate 302 a non-line-of-sight. NLOS, angular offset ϕ_{NLOS} for an NLOS link condition between the first device 1 and the respective second device 2 based on one or more of: the location p₁=[p_{1,x} p_{1,y}] of the first device 1, the location p₂=[p_{2,x} p_{2,y}] of the respective second device 2, the location information pₜₐᵣ=[p_{tar,x} p_{tar,y}] being associated with the target area 4 (e.g., its center), a measurement RTT being associated with a propagation distance of an NLOS path between the first device 1 and the respective second device 2, and a measurement θ₁ being associated with a deflection angle of the NLOS path from a boresight direction at the first device 1:
The LOS angular offset ϕ_{LOS} and the NLOS angular offset ϕ_{NLOS} may respectively comprise one or more of: a horizontal angular offset: and a vertical angular offset.

The third device 3 may further be operable to send 303, to the first device 1 being connectible with the third device 3, one or more of: an indication of one or more reference signal, RS, resources RSᵢ being associated with respective beams of the respective second device 2, and an indication of two or more angular offsets ϕ_{LOS}. ϕ_{NLOS} (abbreviated as ϕⱼ in FIG. 6) relative to a spatial direction of a respective beam being associated with the one or more RS resources RS. The two or more angular offsets ϕ_{LOS}, ϕ_{NLOS} comprise the LOS angular offset ϕ_{LOS} for the LOS link condition between the first device 1 and the respective second device 2, and the NLOS angular offset ϕ_{NLOS} for the NLOS link condition between the first device 1 and the respective second device 2.

The one or more RS resources RSᵢ may respectively comprise one of: a synchronization signal block, SSB, in downlink communication: a channel state information-reference signal, CSI-RS, in downlink communication: and an uplink sounding reference signal, UL-SRS, in uplink communication.

As such, the third device 3 may use beam correspondence to configure the second devices 2 for the sensing of an object in a target area 4, by indicating to the respective second device 2 to transmit/receive on a beam/spatial filter with which it has previously received a specific RS resource. Beam correspondence is defined per RS resource, and has been standardized in 3GPP for UL-SRS and UL-MIMO procedures. For example, for UL-SRS configuration, the indication of a (reference) beam is provided in the SpatialRelation-SRS or SpatialRelation-SRSPos information elements (IEs), through the indication of a specific RS.

The third device 3 may further be operable to receive 310 a report concerning the sensing of the object in the target area 4 from the first device 2.

The first device 1 (top middle of FIG. 6) may comprise one of a user equipment and a base station (greyed out), and may be operable to instruct/configure the second devices 2 for sensing of an object in a target area 4.

Given an involvement of the third device 3 in the sensing of the object in the target area 4, the first device I may be operable to receive 103, from the provided third device 3 being connectible with the first device 1, one or more of: the indication of the one or more RS resources RSᵢ, and the indication of the two or more angular offsets ϕ_{LOS}, ϕ_{NLOS}.

Given no such involvement of the third device 3, the first device 1 may be operable to calculate 101, on its own, the LOS angular offset ϕ_{LOS} based on one or more of: the location p₁=[p_{1,x} p_{1,y}] of the first device 1, the location p₂=[p_{2,x} p_{2,y}] of the respective second device 2, the location information pₜₐᵣ=[p_{tar,x} p_{tar,y}] being associated with the target area 4 (see equation (1) above), and may further be operable to calculate 102, on its own, the NLOS angular offset ϕ_{NLOS} ϕ_{LOS} based on one or more of: the location p₁=[p_{1,x} p_{1,y}] of the first device 1, the location p₂=[p_{2,x} p_{2,y}] of the respective second device 2, the location information pₜₐᵣ=[p_{tar,x} p_{tar,y}] being associated with the target area 4, the measurement RTT being associated with the propagation distance of the NLOS path between the first device 1 and the respective second device 2, and the measurement ϕ₁ being associated with the deflection angle of the NLOS path from the boresight direction at the first device 1 (see equation (1) above).

In any case, the first device 1 is operable to send 104, to a respective second device 2 being connectible with the first device 1, the indication of the one or more RS resources RSᵢ being associated with the respective beams of the respective second device 2, and the indication of the two or more angular offsets ϕ_{LOS}, p_{NLOS} relative to the spatial direction of the respective beam being associated with the one or more RS resources RSᵢ.

The first device 1 may further be operable to provide 105, to the respective second device 2, an indication of the link condition between the first device 1 and the respective second device 2, for each of the two or more angular offsets ϕ_{LOS}, ϕ_{NLOS}.

The indication of the link condition (“LOS/NLOS indicator”) between the first device 1 and the respective second device 2 may be defined per RS resource.

The concept described above, with indication of two offsets per RS resource, may be generalized to the case where multiple offsets with respect to multiple reference beams are indicated per RS resource. The first device 1 may provide the respective second device 2 with a list of angular offsets, accompanied by the reference beam they are related to and the indication whether they correspond to a LOS/NLOS link condition. The reason why the extension to multiple angular offsets with respect to multiple reference beams may be advantageous is that the respective second device 2 might have higher confidence on the link condition of some RS resource compared to the first device 1 (or third device 3, if provided).

An exemplary indication of multiple offsets with respect to multiple reference beams from the first device 1 (or from the third device 3, if provided, via the first device 1) to the second device is shown in Table 1, and an exemplary belief of a second device 2 on the link condition for the reference resources/beams is shown in Table 2:

TABLE 1

| Reference | Offset (degrees) | LOS (1) / NLOS (0) |
|---|---|---|
| SSB#1 | 10 | 1 |
| SSB#1 | 25 | 0 |
| CSI-RS#1 | 5 | 1 |

TABLE 2

| Reference | LOS/NLOS probability |
|---|---|
| SSB#1 | 0.1 |
| CSI-RS#1 | 0.7 |

Each row of Table 1 includes a reference beam/resource, an angular offset relative to the reference beam and an indication whether the angular offset corresponds to a LOS or NLOS link condition. For example, the first row of Table 1 tells the second device 2 that, taking as a reference beam the spatial filter it used for the reception of SSB resource #1 and assuming that the link condition is LOS, it should use an angular offset of 10 degrees with respect to the reference beam, so as to steer its beam to the direction of the target area 4. The second device 2 has its own information about the LOS/NLOS link condition for the reference beams/resources provided in Table 1, which is shown in Table 2. For example, the first row of Table 2 says that, for SSB resource #1, the second device 2 estimates the LOS link condition (i.e., probability) to be 0.1.

The second device 2 may make use of the information in Table 1 and Table 2 to configure its spatial filter. For example, according to the first row of Table 2, it estimates that for SSB #1 the link condition is NLOS with probability 0.9, which is the highest confidence it can have on the link condition of the available reference beams. Hence, according to the second row of Table 1, it uses an offset of 25 degrees with respect to the beam it used for reception of SSB #1 to steer its beam in the direction of the target area 4.

In accordance with a first implementation, the network entity configuring the transmission of a signal from a second device 2 or the reception of a signal at a second device, e.g. a first device 1 or a third device 3, if provided, indicates two angular offsets with respect to a reference beam or direction, which is used for reception or transmission of an RS resource, with an indication which offset corresponds to a LOS link condition and which to a NLOS link condition between the BS and the UE through the RS resource. The RS resource may be obtained based on previous transmissions between the first device 1 and the respective second device 2 or through information about their position and environment.

An example of such an indication, wherein a LOS-NLOS-angularOffsetA IE includes two angular offsets, the first of which corresponding to a LOS link condition and the second one corresponds to an NLOS link condition is as follows:

| | |
|---|---|
| LOS-NLOS-angularOffsetA ::= | SEQUENCE { |
| LOSOffest | INTEGER (−x..y) |
| NLOSOffset | INTEGER (−x..y) |
| } | |

In this example, the indication of LOS/NLOS correspondence of each angular offset is implicit, deduced by the order of the indicated offsets, i.e., the first offset corresponds to LOS and the second one to NLOS.

For example, in case of spatial configuration of an UL-SRS resource transmission, such an indication may be included as an additional field in the SRS-SpatialRelationInfo IE, as follows:

SRS-SpatialRelationInfo ::= SEQUENCE {

| | |
|---|---|
| servingCellId | ServCellIndex OPTIONAL, |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |
| | } |
| angularOffset | LOS-NLOS-angularOffsetA OPTIONAL |
| | } |
| | } |

As a further example, in the case of spatial configuration of a DL-PRS resource reception, such an indication may be included as an additional field in the DL-PRS-QCL-Info-r16 IE, as follows:

DL-PRS-QCL-Info-r16 ::= CHOICE {

| | |
|---|---|
| ssb-r16 | SEQUENCE { |

| | |
|---|---|
| pci-r16 | NR-PhysCellID-r16, |
| ssb-Index-r16 | INTEGER (0..63), |
| rs-Type-r16 | ENUMERATED {typeC, typeD, |
| | typeC-plus-typeD} |
| | }, |

| | |
|---|---|
| dl-PRS-r16 | SEQUENCE { |

| | |
|---|---|
| qcl-DL-PRS-ResourceID-r16 | NR-DL-PRS-ResourceID-r16, |
| qcl-DL-PRS-ResourceSetID-r16 | NR-DL-PRS-ResourceSetID-r16 |
| | } |

| | |
|---|---|
| angularOffset | LOS-NLOS-angularOffsetA |
| | OPTIONAL |
| | } |

The respective second device 2 may make use of the indicated angular offsets and use them along with its information about the link condition to determine the spatial filter used for its intended transmission or reception.

In accordance with a second implementation, the network entity configuring the transmission of a signal from a second device 2 or the reception of a signal at a second device, e.g. a first device 1 or a third device 3, if provided, indicates one angular offset with respect to a reference beam or direction, which is used for reception or transmission of an RS resource, whereby at least two RS resources are provided, with a one-bit indication whether the provided angular offset corresponds to a LOS or NLOS link condition between the first device 1 and the second device 2 through the RS resource. An example of such an indication, wherein a LOS-NLOS-angularOffsetB IE includes an angular offset and an accompanying bit indicating the corresponding link condition through the reference beam is provided as follows:

| LOS-NLOS-angularOffsetB ::= SEQUENCE { | |
|---|---|
| offset | INTEGER (−x..y) |
| relatedToLoS | BIT STRING (SIZE (1)), |
| | } |

Similar to the first implementation, the LOS-NLOS-angularOffsetB IE may, for example, be included as an additional field in the SRS-SpatialRelationInfo IE for the spatial configuration of an UL-SRS resource transmission or as an additional field in the DL-PRS-QCL-Info-r16 for the spatial configuration of a DL-PRS resource reception.

The respective second device 2 may make use of the indicated offset and its information about the link condition to determine the spatial filter used for its intended transmission or reception.

In accordance with a third implementation, the network entity configuring the transmission or reception of the respective second device 2 indicates one or more angular offsets with respect to one or more reference beams or directions, wherein for each reference beam one or two offsets may be indicated, as described in implementations 1 and 2, respectively.

The respective second device 2 may make use of the indicated offset(s) along with its information about the link condition through each of the reference beams, to determine the spatial filter used for its intended transmission or reception.

In accordance with a fourth implementation, certain types of second devices 2, e.g. robots, may move along a trajectory known to the network entity configuring the transmission or reception of the respective second device 2, while carrying out the sensing task. Their movement may or may not be related to the sensing task, e.g. to illuminate the target area 4 from different angles/positions.

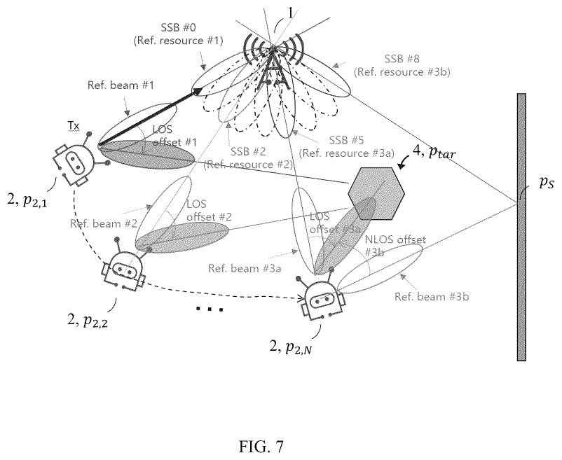

Let p_{2,n}, nε [symbol] be a set of positions of a second device 2 along a trajectory, as shown in FIG. 7 which illustrates an exemplary multistatic sensing scenario in accordance with the present disclosure involving a moving second device 2. The network entity I configuring the transmission or reception of the respective second device 2, knowing the trajectory and the potential presence of objects in the environment, e.g. the reflector shown on the right of FIG. 7, may indicate one or more angular offsets with respect to one or more reference beams used to receive or transmit an RS resource, as described in the third implementation, for each position p_{2,n} along the trajectory. The network entity 1 may signal the angular offsets to be used at positions along the trajectory before the moving second device 2 has reached these positions, e.g. the first device I may signal all the angular offsets to be used along the second device's 2 trajectory when the second device 2 is at its initial position, and, then, the second device 2 may select the relevant angular offset when it reaches each position. In the example shown in FIG. 7 and Table 3 below, SSB resources are used as RS resources, with the offsets defined with respect to the reference beams used to receive these RS resources. For example, for UE position #N, the first device 1 provides an angular offset with respect to the reference beam used to receive SSB#5, indicating that the angular offset corresponds to a LOS link condition, and an angular offset with respect to the reference beam used to receive SSB#8, indicating that the offset corresponds to an NLOS link condition.

TABLE 3

| Position | Reference | Offset (degrees) | LOS (1) / NLOS (0) |
|---|---|---|---|
| #1 | SSB #0 | −40 | 1 |
| #2 | SSB #2 | −38 | 1 |
| . . . | . . . | . . . | . . . |
| #N | SSB #5 | 45 | 1 |
| | SSB #8 | 40 | 0 |

The first device 1 may further be operable to receive 108, from the respective second device 2, one or more of: an indication of one of the one or more RS resources RSᵢ being associated with a spatial filter of the respective second device 2, an indication of one of the two or more angular offsets ϕ_{LOS}, ϕ_{NLOS} being associated with the spatial filter of the respective second device 2, and an indication of a LOS probability being associated with the indicated one of the one or more RS resources RSᵢ.

The first device 1 may further be operable to receive 109 a report concerning the sensing of the object in the target area 4 from the respective second device 2.

The first device 1 may further be operable to send 110 a report concerning the sensing of the object in the target area 4 to the third device 3.

Depending on the multistatic sensing scenario, the second devices 2 (one being shown at the top right of FIG. 6) may comprise base stations (or transmission/reception points) and/or user equipments (greyed out), and may be operable to carry out the sensing of the object in the target area 4, by transmitting or receiving a probe signal.

The respective second device 2 is operable to receive 204, from the first device 1 being connectible with the respective second device 2, the indication of the one or more RS resources RSᵢ being associated with the respective beams of the respective second device 2, and the indication of the two or more angular offsets ϕ_{LOS}, ϕ_{NLOS} relative to the spatial direction of the respective beam being associated with the one or more RS resources RSᵢ. The two or more angular offsets ϕ_{LOS}, ϕ_{NLOS} comprise the LOS angular offset ϕLos for the LOS link condition between the first device I and the respective second device 2, and the NLOS angular offset ϕ_{NLOS} for the NLOS link condition between the first device 1 and the respective second device 2.

The respective second device 2 may further be operable to receive 205, from the first device 1, the indication of the link condition between the first device 1 and the respective second device 2, for each of the two or more angular offsets ϕ_{LOS}, ϕ_{NLOS}.

The respective second device 2 is further operable to configure 206 a spatial filter of the respective second device 2 in a spatial direction toward the target area 4 based on one of the one or more RS resources RSᵢ, and on one of the two or more angular offsets ϕ_{LOS}, ϕ_{NLOS} in accordance with an actual link condition between the first device 1 and the respective second device 2 as observed by the respective second device 2.

The respective second device 2 is further operable to probe 207 the target area 4 using the configured spatial filter.

More specifically, the respective second device 2 may be operable to probe 207T the target area 4 using the configured spatial filter by transmitting a probe signal, in which case the respective second device 2 may comprise one of: a base station (or a transmission/reception point) in downlink communication, a user equipment in uplink communication, and a user equipment in sidelink communication.

Alternatively, the respective second device 2 may be operable to probe 207R the target area 4 using the configured spatial filter by receiving the probe signal, in which case the respective second device 2 may comprise one of: a user equipment in downlink communication, a base station (or a transmission/reception point) in uplink communication, and a user equipment in sidelink communication.

The respective second device 2 may further be operable to provide 208, to the first device 1, one or more of: the indication of the one of the one or more RS resources RSᵢ being associated with the spatial filter of the respective second device 2, the indication of the one of the two or more angular offsets ϕ_{LOS}, ϕ_{NLOS} being associated with the spatial filter of the respective second device 2, and the indication of a LOS probability being associated with the indicated one of the one or more RS resources RSᵢ.

The respective second device 2 may further be operable to: send 209 a report concerning the sensing of the object in the target area 4 to the first device 1. In particular, sending 209 the report may include providing 208 the indications.

The present disclosure has been described in conjunction with various exemplary implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A first device for sensing of an object in a target area, the first device comprising a non-transitory computer-readable storage medium storing a computer program that causes the first device to be configured to:
send, to a second device being connectible with the first device, an indication of one or more reference signal (RS) resources being associated with respective beams of the second device, and an indication of two or more angular offsets relative to a spatial direction of a respective beam being associated with the one or more RS resources,
wherein the two or more angular offsets comprise a line-of-sight (LOS) angular offset for a LOS link condition between the first device and the second device, and
a non-line-of-sight (NLOS) angular offset for an NLOS link condition between the first device and the second device.

2. The first device of claim 1, further configured to receive a report from the second device.

3. The first device of claim 1, further configured to receive, from a third device being connectible with the first device, one or more of:
the indication of the one or more RS resources; and
the indication of the two or more angular offsets; and
send a report to the third device.

4. The first device of claim 1, further configured to provide, to the second device, an indication of the link condition between the first device and the second device, for each of the two or more angular offsets.

5. The first device of claim 1, further configured to calculate the LOS angular offset based on one or more of:
a first location of the first device,
a second location of the second device, and
a location information being associated with the target area.

6. The first device of claim 1, further configured to calculate the NLOS angular offset (ϕ_{LOS}) based on one or more of:
the first location of the first device,
a second location of the second device,
location information being associated with the target area,
a first measurement being associated with a propagation distance of an NLOS path between the first device and the second device, and
a second measurement being associated with a deflection angle of the NLOS path from a boresight direction at the first device.

7. The first device of claim 1, further configured to receive, from the second device, one or more of:
an indication of one of the one or more RS resources being associated with a spatial filter of the second device,
an indication of one of the two or more angular offsets being associated with the spatial filter of the second device, and
an indication of a LOS probability being associated with an indicated one of the one or more RS resources.

8. The first device of claim 1, comprising one of a base station, and a user equipment.

9. A third device for sensing of an object in a target area, the third device comprising a non-transitory computer-readable storage medium storing a computer program that causes the third device to be configured to send, to a first device being connectible with the third device, one or more of:
an indication of one or more reference signal (RS) resources being associated with respective beams of a second device, and
an indication of two or more angular offsets relative to a spatial direction of a respective beam being associated with the one or more RS resources,
wherein the two or more angular offsets comprise a line-of-sight (LOS) angular offset for a LOS link condition between the first device and the second device, and a non-line-of-sight (NLOS) angular offset for an NLOS link condition between the first device and the second device.

10. The third device of claim 9, further configured to receive a report from the first device.

11. The third device of claim 9, further configured to calculate the LOS angular offset based on one or more of:
a first location of the first device,
a second location of the second device, and
a location information being associated with the target area.

12. The third device of claim 9, further configured to calculate the NLOS angular offset (ϕ_{LOS}) based on one or more of:
the first location of the first device,
a second location of the second device,
location information being associated with the target area,
a first measurement being associated with a propagation distance of an NLOS path between the first device and the second device, and
a second measurement being associated with a deflection angle of the NLOS path from a boresight direction at the first device.

13. A second device for sensing of an object in a target area, wherein the second device comprises a non-transitory computer-readable storage medium storing a computer program that causes the second device to be configured to receive, from a first device being connectible with the second device, an indication of one or more reference signal (RS) resources being associated with respective beams of the second device, and an indication of two or more angular offsets relative to a spatial direction of a respective beam being associated with the one or more RS resources,
wherein the two or more angular offsets comprise a line-of-sight (LOS) angular offset for a LOS link condition between the first device and the second device, and a non-line-of-sight (NLOS) angular offset for an NLOS link condition between the first device and the second device:
configure a spatial filter of the second device in a spatial direction toward the target area based on one of the one or more RS resources, and one of the two or more angular offsets in accordance with an actual link condition between the first device and the second device as observed by the second device: and
probe the target area using the configured spatial filter.

14. The second device of claim 13, further configured to send a report to the first device.

15. The second device of claim 13, comprising one of:
a base station or a transmission/reception point in downlink communication, a user equipment in uplink communication, and a user equipment in sidelink communication; and
the second device further configured to probe the target area using the configured spatial filter by transmitting a probe signal.

16. The second device of claim 13, comprising one of:
a user equipment in downlink communication,
a base station or a transmission/reception point in uplink communication, and
a user equipment in sidelink communication: and
the second device further configured to probe the target area using the configured spatial filter by receiving a probe signal.

17. The second device of claim 13, further configured to receive, from the first device, an indication of the link condition between the first device and the second device, for each of the two or more angular offsets.

18. The second device of claim 13, further configured to provide, to the first device, one or more of:
an indication of one of the one or more RS resources being associated with the spatial filter of the second device,
an indication of one of the two or more angular offsets being associated with the spatial filter of the second device, and
an indication of a LOS probability being associated with the indicated one of the one or more RS resources.

19. The second device of claim 13, wherein the one or more RS resources respectively comprising one of:
a synchronization signal block (SSB) in downlink communication;
a channel state information-reference signal (CSI-RS) in downlink communication; and
an uplink sounding reference signal (UL-SRS) in uplink communication.

20. The second device of claim 13, wherein the LOS angular offset and the NLOS angular offset (ϕ_{LOS}) respectively comprise one or more of:
a horizontal angular offset; and
a vertical angular offset.
